(19) United States
(12) Patent Application Publication
(10) Pub. No.: US 2016/0120200 A1
(43) Pub. Date: May 5, 2016

(54) FAT AND/OR OIL COMPOSITION FOR HEAT COOKING AND METHOD FOR MANUFACTURING THE FAT AND/OR OIL COMPOSITION FOR HEAT COOKING

(71) Applicant: The Nisshin OilliO Group, Ltd., Tokyo (JP)

(72) Inventors: Yoshihiro MURANO, Kamakura-shi (JP); Reiko EJIRI, Yokohama-shi (JP); Takahide WATANABE, Tokyo (JP); Kanji AOYAGI, Tokyo (JP)

(73) Assignee: THE NISSHIN OILLIO GROUP, LTD., Tokyo (JP)

(21) Appl. No.: 14/926,226

(22) Filed: Oct. 29, 2015

(30) Foreign Application Priority Data
Oct. 31, 2014 (JP) 2014-222361

(51) Int. Cl. A23D 9/007; A23D 9/02

(52) U.S. Cl. CPC A23D 9/007; A23D 9/02

(57) ABSTRACT

Disclosed is a fat and/or oil composition for heat cooking including 1 to 5 ppm by mass of silicone oil having a kinetic viscosity of 800 to 5,000 mm²/s at a temperature of 25° C., and 0.03 to 0.09% by mass of a succinic acid monoglyceride or 0.05 to 0.11% by mass a citric acid monoglyceride in a fat and/or oil; and a method for manufacturing the fat and/or oil composition for heat cooking.

### TECHNICAL FIELD

This disclosure relates to a fat and/or oil composition for heat cooking, and a method for manufacturing the fat and/or oil composition for heat cooking.

### BACKGROUND

In recent years, an increasing number of health-oriented consumers have driven a demand for low fat foods. Patent Literature 1 (PTL 1), for example, discloses a fat and/or oil composition for stir-frying that allows a reduction in the amount of oil absorbed in a cooked food during frying and that provides a satisfactory taste and flavor. The disclosed fat and/or oil composition reduces the oil absorption in a cooked object with addition of an emulsifier.

In fry cooking such as frying, tempura cooking, and deep-frying, however, the heat cooking is performed in oil, so that the water content in a food to be cooked is more easily substituted with oil in comparison with in stir-frying. Consequently, even with use of the fat and/or oil composition described in PTL 1, it is difficult to obtain the similar effect as in stir-frying. Since the batter with a high water content of fried foods has properties to easily absorb the oil content, it is desired to achieve further efficient reduction in oil absorption, while maintaining the good taste and flavor. In principle, the effect in reducing oil absorption can be enhanced with increase in the amount of an emulsifier to be added. However, it is difficult to add a large amount of the emulsifier due to the increase in the raw material cost, deterioration in the original taste and flavor of the oil, and the like.

Further, the fat and/or oil for fry cooking for business use in back yards of supermarkets or in food service industries is used under conditions different from those for home use. More specifically, the fat and/or oil is kept in a heated state for longer hours and a larger number of ingredients are fried therein. Due to the large load on the oil, the direct use of an oil for frying at home requires frequent replacement of the oil resulting from the fast oil deterioration rate. The fat and/or oil for frying for distribution and use in business, therefore, typically includes about several ppm by mass of silicone oil. It is known that the silicone oil slows down the deterioration rate of the fat and/or oil by forming a coating film at the gas-liquid interface so as to block the contact between the fat and/or oil and oxygen to the utmost and facilitates the dissipation of bubbles to be formed in the heated fat and/or oil.

In a silicone oil-containing fat and/or oil composition, the silicone oil forms a coating film at the gas-liquid interface. Accordingly, the means for reducing the fat and/or oil absorption for a fat and/or oil composition for heat cooking which includes no silicone oil is not necessarily effective for a fat and/or oil composition for heat cooking which includes silicone oil. Further, it is conceivable that in the case of a silicone oil-containing fat and/or oil composition with addition of an emulsifier, the silicone oil which forms a coating film at the gas-liquid interface may have a bad influence on the effect of the emulsifier for reducing the fat and/or oil absorption, due to the interaction with the emulsifier having impact on the gas-liquid or liquid-liquid interfacial tension.

### CITATION LIST

### Patent Literature

PTL 1: Japanese Patent Laid-Open No. 2005-218380

### SUMMARY

It could therefore be helpful to provide: a fat and/or oil composition for heat cooking, capable of efficiently reducing the fat and/or oil content remaining in the cooked food and imparting an excellent taste and flavor, and excellent texture, when heat cooked in a silicone oil-containing fat and/or oil composition; and a method for manufacturing the fat and/or oil composition for heat cooking.

The fat and/or oil composition for heat cooking according to the disclosure includes:

a fat and/or oil;

1 to 5 ppm by mass of silicone oil having a kinetic viscosity of 800 to 5,000 mm²/s at a temperature of 25° C.; and

0.03 to 0.09% by mass of a succinic acid monoglyceride or 0.05 to 0.11% by mass of a citric acid monoglyceride.

In the fat and/or oil composition for heat cooking, the succinic acid monoglyceride or the citric acid monoglyceride is preferably glyceryl monooleate succinate or glyceryl monooleate citrate, respectively.

The method for manufacturing a fat and/or oil composition for heat cooking according to the disclosure includes the steps of:

refining a fat and/or oil; and thereafter

adding 1 to 5 ppm by mass of silicone oil having a kinetic viscosity of 800 to 5,000 mm²/s at a temperature of 25° C., and 0.03 to 0.09% by mass of a succinic acid monoglyceride or 0.05 to 0.11% by mass of a citric acid monoglyceride to the refined fat and/or oil.

In the method for manufacturing a fat and/or oil composition for heat cooking, the succinic acid monoglyceride or the citric acid monoglyceride is preferably glyceryl monooleate succinate or glyceryl monooleate citrate, respectively.

The fat and/or oil composition for heat cooking and the method for manufacturing a fat and/or oil composition for heat cooking according to the disclosure allow the oil content remaining in a cooked food to be efficiently reduced with use of a silicone oil-containing fat and/or oil composition in heat cooking. The blending amount of a succinic acid monoglyceride or a citric acid monoglyceride is small, so that an excellent taste and flavor close to the original taste and flavor of a fat and/or oil and an excellent texture can be imparted to the cooked food at a low manufacturing cost.

From such advantages, the fat and/or oil composition for heat cooking according to the disclosure can be suitably used as frying oil in cooking fried foods such as tempura and fried chicken called karaage, in particular. It also can be suitably used in stir-frying.

### DETAILED DESCRIPTION

The fat and/or oil composition for heat cooking according to the disclosure includes: a fat and/or oil; 1 to 5 ppm by mass of silicone oil having a kinetic viscosity of 800 to 5,000 mm²/s at a temperature of 25° C.; and 0.03 to 0.09% by mass of a succinic acid monoglyceride or 0.05 to 0.11% by mass of a citric acid monoglyceride.

Examples of the method for reducing the oil content in a fried food such as tempura include: (1) reducing the deposition of a batter which easily absorbs fat and/or oil to make the thin batter coating; (2) reducing the fat and/or oil content to be absorbed in the batter coating; (3) reducing the fat and/or oil content to be absorbed in a foodstuff; and (4) facilitating de-oiling after frying (draining fat and/or oil after frying). Since, in a fried food such as tempura, a large part of the fat and/or oil is contained in the batter coating than in the fried ingredient (foodstuff inside the batter coating), the method (2) described above, i.e. reducing the fat and/or oil content to be absorbed in the batter coating, in particular, can be effective in reducing the oil content in a cooked food.

As a result of extensive study for manufacturing a fat and/or oil composition which is hardly absorbed in the batter coating of a fried food and is easy to be drained, this disclosure discovered that use of a silicone oil-containing fat and/or oil component with addition of 0.03 to 0.09% by mass of a succinic acid monoglyceride or 0.05 to 0.11% by mass of a citric acid monoglyceride can reduce the amount of the fat and/or oil absorbed in a cooked food on fry cooking. Based on the finding, the disclosure provides a fat and/or oil composition for heat cooking which can efficiently reduce a fat and/or oil absorption in a cooked food, with addition of a small amount of a succinic acid monoglyceride or a citric acid monoglyceride.

### Fat and/or Oil Composition for Heat Cooking

The fat and/or oil composition for heat cooking according to the disclosure is described for each of the components as follows.

### 1. Fat and/or Oil

The fat and/or oil composition for heat cooking according to the disclosure includes conventional fats and/or oils for heat cooking as main component. The conventional fats and/or oils for use may be animal and vegetable fats and/or oils, hydrogenated fats and/or oils, fractionated fats and/or oils, and transesterified fats and/or oils thereof for commonly used in heat cooking, which may be used alone or in combination. Examples of the animal and vegetable fats and/or oils include soybean oil, rapeseed oil, high oleic rapeseed oil, sunflower oil, high oleic sunflower oil, olive oil, safflower oil, high oleic safflower oil, corn oil, cottonseed oil, rice bran oil, beef tallow, milk fat, fish oil, coconut oil, palm oil, and palm kernel oil. Since the fats and/or oils which are solidified at room temperature need to be heated for melting for use, the fats and/or oils in a liquid state at a temperature of 20° C. are preferred. In the case of using a raw material fat and/or oil in a solid state at a temperature of 20° C. in combination with another raw material fat and/or oil, the resulting fat and/or oil in a liquid state may be preferably used. In particular, rapeseed oil or a mixture of rapeseed oil and soybean oil can be preferably used, with an advantage having a low melting point as a liquid oil with excellent oxidative stability.

In the fat and/or oil composition for heat cooking according to the disclosure, the conventional fats and/or oils for heat cooking preferably constitute the balance except for the silicone oil, the succinic acid monoglyceride or the citric acid monoglyceride, and the other additives to be added on an as needed basis.

### 2. Silicone Oil

The fat and/or oil composition for heat cooking according to the disclosure contains a silicone oil. The silicone oil for use has a dimethylpolysiloxane structure, with a kinetic viscosity of 800 to 5,000 m²/s at a temperature of 25° C. The kinetic viscosity of the silicone oil at a temperature of 25° C. is preferably 800 to 2,000 m²/s, more preferably 900 to 1,100 m²/s. With a kinetic viscosity of the silicone oil of less than 800 m²/s at a temperature of 25° C., the effect for suppressing foaming of a heated fat and/or oil composition is insufficient. With a kinetic viscosity of the silicone oil of more than 5,000 m²/s at a temperature of 25° C., the dissolution in the fat and/or oil composition is difficult. The silicone oil for use may be a commercially available product for food applications. The term “kinetic viscosity” used herein is a value measured in accordance with JIS K 2283 (2000). The silicone oil may include microparticulate silica other than silicone oil components.

The silicone oil content in the fat and/or oil composition for heat cooking according to the disclosure is 1 to 5 ppm by mass, preferably 1 to 4 ppm by mass, more preferably 2 to 3 ppm by mass. With a total silicone content of less than 1 ppm by mass, the effect for suppressing foaming in cooking is insufficient. With a total silicone content of more than 5 ppm by mass, evaporation of water from the surface of the fat and/or oil is difficult, and foaming may be facilitated in some cases.

### 3. Succinic Acid Monoglyceride and Citric Acid Monoglyceride

The functions of the succinic acid monoglyceride or the citric acid monoglyceride in cooking a fried food such as tempura are as follows. For example, in cooking of tempura, a foodstuff and a batter (i.e., mixture of tempura flour and water) are heated in the fat and/or oil at high temperature (160 to 200° C.). When the batter comes in contact with the fat and/or oil at high temperature, the water content is rapidly evaporated and dissipated at the contact surface with the fat and/or oil, and the solid content in the batter mainly composed of wheat flour is solidified by baking. The phenomenon is repeated, so that the water in the batter is gradually removed to form a batter coating having a network structure in a shape having voids, formed of solidified wheat flour by baking. A commonly used emulsifier effects on the gas-liquid or liquid-liquid interfacial tension. The succinic acid monoglyceride and the citric acid monoglyceride change the interfacial tension between “oil (fat) and solid”, “oil (fat) and water” or “oil (fat) and gas (steam)” when formed a batter coating, so that the properties of a batter (shape, composition, and physical properties) are changed.

The succinic acid monoglyceride may include oleic acid, erucic acid, stearic acid, palmitic acid, a mixture fatty acid of these fatty acids, or a mixture fatty acid derived from palm oil, rapeseed oil, safflower oil, and soybean oil, as the constituent fatty acid. Examples thereof include glyceryl monooleate succinate, succinic acid erucic acid monoglyceride, succinic acid stearic acid monoglyceride, and succinic acid palmitic acid monoglyceride, and glyceryl monooleate succinate is particularly preferred. For example, “SUNSOFT 683CB” (manufactured by Taiyo Kagaku Co., Ltd.) may be used as the glyceryl monooleate succinate. These succinic acid monoglycerides may be used alone or may be mixed for use. The citric acid monoglyceride may include oleic acid, erucic acid, stearic acid, palmitic acid, a mixture fatty acid of these fatty acids, or a mixture fatty acid derived from palm oil, rapeseed oil, safflower oil, and soybean oil, as the constituent fatty acid. Examples thereof include glyceryl monooleate citrate, citric acid erucic acid monoglyceride, citric acid stearic acid monoglyceride, and citric acid palmitic acid monoglyceride, and glyceryl monooleate citrate is particularly preferred. For example, “SUNSOFT PLUS F” (manufactured by Taiyo Kagaku Co., Ltd.) may be used as the glyceryl monooleate citrate. These citric acid monoglycerides may be used alone or may be mixed for use. As the succinic acid monoglyceride and the citric acid monoglyceride for use, products on the market for food additives may be appropriately used.

The blending amount of succinic acid monoglyceride is 0.03 to 0.09% by mass, preferably 0.04 to 0.08% by mass, more preferably 0.06 to 0.08% by mass, relative to the fat and/or oil composition for heat cooking according to the disclosure. The blending amount of the citric acid monoglyceride is 0.05 to 0.11% by mass, preferably 0.06 to 0.10% by mass, more preferably 0.07 to 0.09% by mass, relative to the fat and/or oil composition for heat cooking. As described below, also in the fat and/or oil composition for heat cooking which contains 1 to 5 ppm by mass of silicone oil having a kinetic viscosity of 800 to 5,000 mm²/s at a temperature of 25° C., the oil absorption in a food to be cooked with heat can be minimized with addition of the succinic acid monoglyceride or the citric acid monoglyceride in the blending amount.

### 4. Other Components

In the fat and/or oil composition for heat cooking, other components may be added within a range not impairing the effect of the disclosure. The other components are, for example, components for use in a conventional fat and/or oil (e.g. food additives). Examples of the components include antioxidants, crystal modifiers, texture improvers, and emulsifiers, which are preferably added after deodorizing and before filling.

Examples of the antioxidant include tocopherols, ascorbic acids, flavone derivative, kojic acid, gallic acid derivatives, catechin and esters thereof, butterburic acid, gossypol, sesamol, the terpens. Examples of the coloring components include carotene and astaxanthin. Other emulsifiers having no impact on the effect for reducing the oil absorption may be appropriately selected from a sucrose fatty acid ester, a sorbitan fatty acid ester, a polysorbate, a propylene glycol fatty acid ester, a polyglycerin condensed ricinoleate, diacylglycerol, waxes, styrol esters, and a phospholipid.

### Method for Manufacturing Fat and/or Oil Composition for Heat Cooking

The fat and/or oil for use in the fat and/or oil composition for heat cooking according to the disclosure may be manufactured by using a crude oil squeezed from plant seeds or fruits, or animal materials as starting raw material in the same way as in manufacturing of conventional fats and/or oils, including the successive steps of degumming, deoxidizing, decoloring, and dewaxing, on an as needed basis, and then refining after deodorizing. The steps of degumming, deoxidizing, and dewaxing are appropriately selected corresponding to the quality of the crude oil which is variable depending on the raw material of the oil before oil extraction.

In addition to the step of refining a fat and/or oil as described above, the manufacturing method according to the disclosure includes the step of adding 1 to 5 ppm by mass of silicone oil having a kinetic viscosity of 800 to 5,000 mm²/s at a temperature of 25° C., and 0.03 to 0.09% by mass of a succinic acid monoglyceride or 0.05 to 0.11% by mass a citric acid monoglyceride to the fat and/or oil. The silicone oil and the succinic acid monoglyceride or the citric acid monoglyceride are preferably added to and dissolved in the heated fat and/or oil after the refining step for blending. The manufacturing method may include the step of adding other additives on an as needed basis. The step of adding the other additives is preferably performed after the step of refining the fat and/or oil. The conditions for the addition, e.g. the fat and/or oil temperature, are preferably appropriately changed depending on the type of the additive and the purpose.

According to the disclosed method for manufacturing a fat and/or oil composition for heat cooking, a fat and/or oil composition for heat cooking capable of efficiently reducing the oil content remaining in a food to be cooked can be obtained by using a silicone oil-containing fat and/or oil composition in heat cooking.

### EXAMPLES

The disclosed products and methods are more specifically described with reference to Examples as follows, but are not limited thereto.

### Test 1: Test for Measuring Oil Amount in Tempura Batter Coating

According to the following method, the fat and/or oil amount remaining in a batter coating was measured by using a model test system having a tempura batter only, with no ingredient to be fried. The tempura batter coating was made in a fat and/or oil composition for heat cooking, including a silicone oil and a succinic acid monoglyceride.

### 1. Sample Preparation

A silicone oil “KF-96 1000CS” (manufactured by Shin-Etsu Chemical Co., Ltd., kinetic viscosity: 1,000 mm²/s at 25° C.) in an amount of 3 ppm by mass and glyceryl monooleate succinate “SUNSOFT 683CB” (HLB value: 8.5, manufactured by Taiyo Kagaku Co., Ltd.) in each amount specified in Table 1 were added to and mixed with a base oil which is a mixture of a refined rapeseed oil “NISSHIN CANOLA OIL” (manufactured by Nisshin OilliO Group, Ltd.) and a refined soybean oil “NISSHIN SOYBEAN SALAD OIL (S)” (manufactured by Nisshin OilliO Group, Ltd.) at a ratio of 5:5, including no silicone oil, so that oil compositions for heat cooking (fat and/or oil for frying) were prepared. Glyceryl monooleate succinate was added to and dissolved in 800 g of a oil heated at 180° C. in an iron pan, so as to be added to and mixed with the base oil.

A batter was made by mixing 38 g of tempura flour “SHOWA TEMPURA FLOUR” (manufactured by Showa Sangyo Co., Ltd.) with 62 g of iced water.

In each of cup-shaped iron containers, 3.5 g of the batter was sampled. Five pieces of the containers were fed into each of the oil compositions for frying heated to a temperature of 180° C. in an iron pan, and heated for 3 minutes. On this occasion, after feeding, the batters were detached from the cup, and came to the surface so as to form batter coatings, while the cup-shaped containers settled down. After an elapsed time of 1.5 minutes, the batter coatings were turned over. After an elapsed time of 3 minutes, the batter coatings were transferred onto a net and left standing for 5 minutes for draining the oil. The samples for measurement were thus prepared.

Ten pieces of the batter coatings were made for each or oil for frying which contains glyceryl monooleate succinate in the specified amount.

### 2. Measurement of Fat and/or Oil Content

The measurement sample (the batter coating heat cooked) was weighed and then dried under reduced pressure for removal of water. The water content was calculated from the weights measured before and after the drying.

The sample after drying was immersed in hexane, so that the fat and/or oil content in the batter coating was eluted into the hexane fraction (fat and/or oil content extraction). The hexane fraction was collected and hexane was removed. The remaining fat and/or oil content was then weighed. The average of 10 samples was assumed to be the fat and/or oil amount. The weight of the fat and/or oil content divided by the sample weight before drying was assumed to be the fat and/or oil content ratio. The fat and/or oil amount and the fat and/or oil content ratio of the samples using each fat and/or oil for frying are described in Table 1.

TABLE 1

| | Added amount (% by mass) | | | | | | |
|---|---|---|---|---|---|---|---|
| | of glyceryl monooleate succinate | | | | | | |
| | 0 | 0.02 | 0.04 | 0.06 | 0.08 | 0.10 | 0.12 |
| Oil amount (g) | 2.15 | 2.27 | 2.16 | 2.01 | 1.84 | 2.01 | 2.29 |
| Oil content ratio (%) | 59.6 | 61.8 | 56.9 | 55.8 | 51.1 | 54.7 | 61.2 |

### 3. Analysis of Measurement Results

As shown in Table 1, it was found that when glyceryl monooleate succinate was added to a silicone oil-containing fat and/or oil for heat cooking, the added amount is not necessarily proportional to the reduced amount in the fat and/or oil amount and the fat and/or oil content ratio of the produced sample (the tempura batter coating). Namely, it was found that with an excessively large or excessively small amount of glyceryl monooleate succinate added to a silicone oil-containing fat and/or oil for heat cooking, the amount of oil absorbed in a fried food such as tempura cannot be reduced and is rather increased. Accordingly, in order to effectively reduce the amount of fat and/or oil absorbed in a fried food, the amount of glyceryl monooleate succinate added to a silicone oil-containing fat and/or oil for heat cooking needs to be optimized.

### Test 2: Experiment to Verify the Effect on Tempura

A fat and/or oil compositions for heat cooking which contains silicone oil and a succinic acid monoglyceride or a citric acid monoglyceride were prepared. Using the fat and/or oil composition, a tempura was actually cooked and the effect of reducing fat and/or oil content in the cooked food was confirmed.

### 1. Sample Preparation

A silicone oil “KF-96 1000CS” (manufactured by Shin-Etsu Chemical Co., Ltd., kinetic viscosity: 1,000 mm²/s at 25° C.) in an amount of 3 ppm by mass and glyceryl monooleate succinate “SUNSOFT 683CB” (HLB value: 8.5, manufactured by Taiyo Kagaku Co., Ltd.) or glyceryl monooleate citrate “SUNSOFT PLUS F” (HLB value: 7.0, manufactured by Taiyo Kagaku Co., Ltd.) in each amount specified in Table 2 were added to and mixed with a base oil which is a mixture of a refined rapeseed oil “NISSHIN CANOLA OIL” (manufactured by Nisshin Oillio Group, Ltd.) and a refined soybean oil “NISSHIN SOYBEAN SALAD OIL (S)” (manufactured by Nisshin Oillio Group, Ltd.) at a ratio of 5:5, including no silicone oil, so that oil compositions for heat cooking (fat and/or oil for frying) of Examples 1 and 2 were prepared. The glyceryl monooleate succinate or the glyceryl monooleate citrate was added to and dissolved in 1,000 g of the oil heated to a temperature of 180° C. in an iron pan, so as to be added to and mixed with the base oil. On the other hand, a oil with addition of glyceryl monooleate succinate “SUNSOFT 683CB” (manufactured by Taiyo Kagaku Co., Ltd.) in each specified amount, with no addition of silicone oil, was prepared as

### Reference Example 1.

A sweet potato was cut into a cylindrical shape having a thickness of 5 mm and a diameter of 3.4 cm, as the ingredient to be fried. A batter was made by mixing 38 g of tempura flour “SHOWA TEMPURA FLOUR” (manufactured by Showa Sangyo Co., Ltd.) with 62 g of iced water. The sweet potato was immersed in the batter, so as to be adhered to the batter.

Five pieces of sweet potatoes to which the batter was adhered were fed into each of the oil for frying heated to a temperature of 180° C. in an iron pan, and cooked with heat for 3 minutes. On this occasion, after an elapsed time of 1.5 minutes from the initiation of the heat cooking, the sweet potatoes in the oil for frying were once turned over. After heat cooking for 3 minutes, the fried foods were transferred onto a net and left standing for 5 minutes for draining the oil. The samples for measurement were thus prepared.

Ten pieces of the fried food samples were made for each oil for frying.

### 2. Measurement of Fat and/or Oil Content

The sample (fried food) was weighed and then dried under reduced pressure for removal of water. The water content was calculated from the weights measured before and after the drying.

The sample after drying was immersed in 30 mL of hexane, so that the fat and/or oil content in the sample was eluted into the hexane fraction (oil content extraction). The hexane fraction was collected and hexane was removed. The remaining fat and/or oil content was then weighed. The average of 10 samples was assumed to be the fat and/or oil amount. The fat and/or oil amount divided by the sample weight before drying was assumed to be the oil content ratio. The fat and/or oil amount and the fat and/or oil content ratio (%) of the samples using each fat and/or oil for frying are described in Table 2.

TABLE 2

| | | | Added amount (% by mass) | | | | | | |
|---|---|---|---|---|---|---|---|---|---|
| | | | of glyceryl monooleate succinate or citrate | | | | | | |
| | | | 0 | 0.02 | 0.04 | 0.06 | 0.08 | 0.10 | 0.12 |
| Ref. | Silicone | Glyceryl | 20.9 | 19.2 | 19.6 | 18.9 | 19.0 | 21.7 | — |
| Ex.*1 | oil-free | monooleate | | | | | | | |
| | | succinate | | | | | | | |
| Ex.**1 | Silicone | Glyceryl | 20.9 | 20.5 | 19.9 | 18.3 | 18.2 | 20.4 | 19.7 |
| | oil added | monooleate | | | | | | | |
| | | succinate | | | | | | | |
| Ex.2 | Silicone | Glyceryl | 20.9 | 21.2 | 21.0 | 20.0 | 19.9 | 20.0 | 21.7 |
| | oil added | monooleate | | | | | | | |
| | | citrate | | | | | | | |

*“Ref. Ex.” means “Reference Example”.
**“Ex.” means “Example”.

As shown in Table 2, it was found that when glyceryl monooleate succinate was added to a silicone oil-containing fat and/or oil for heat cooking (Example 1), the fat and/or oil content ratio of the resulting sample (tempura) was reduced with an amount of about 0.03 to 0.09% by mass. Namely, it was found that with an amount of glyceryl monooleate succinate of about 0.03 to 0.09% by mass added to a silicone oil-containing fat and/or oil for heat cooking, the amount of the fat and/or oil absorbed in a fried food such as tempura can be effectively reduced.

Further, in the case of adding glyceryl monooleate citrate to a silicone oil-containing fat and/or oil for heat cooking (Example 2), it was found that with an amount added of about 0.05 to 0.11% by mass, the fat and/or oil content ratio in a resulting sample (tempura) was reduced. Namely, it was found that with an amount of glyceryl monooleate citrate of about 0.05 to 0.11% by mass added to a silicone oil-containing fat and/or oil for heat cooking, the amount of the fat and/or oil absorbed in a fried food such as tempura can be effectively reduced.

From the comparison of Example 1 with Reference Example 1, it was also found that in the case of adding a silicone oil, the range of the amount of glyceryl monooleate succinate added capable of efficiently reducing the fat and/or oil absorption in a fried food is shifted toward the high-concentration direction in comparison with the case of adding no silicone oil.

### 3. Evaluation of Taste and Flavor and Texture

The experimental sample preparation in Test 2 (Examples 1 and 2) was made again for evaluation of the taste and flavor and the texture of batter coating (crispiness) of each sample.

Taste and flavor: In comparison with the sample fried in the base oil (amount of glyceryl monooleate succinate and glyceryl monooleate citrate added: 0% by mass, hereinafter referred to as “additive-free product”), a sample having the same taste and flavor was evaluated as “equivalent”, a sample having a better taste and flavor was evaluated as “excellent”, a sample having an worsened taste and flavor was evaluated as “poor”. The results are shown in Table 3.

Texture of batter coating: In comparison with the sample fried in the base oil (additive-free product), a sample having the same crispiness was evaluated as “equivalent”, a sample having better crispiness was evaluated as “excellent”, and a sample having less (inferior) crispiness was evaluated as “poor”. The results are shown in Table 4.

TABLE 3

| | | | Added amount (% by mass) | | | | | | |
|---|---|---|---|---|---|---|---|---|---|
| | | | of glyceryl monooleate succinate or citrate | | | | | | |
| | | | 0 | 0.02 | 0.04 | 0.06 | 0.08 | 0.10 | 0.12 |
| Ex.*1 | Silicone | Glyceryl | — | Equiv.** | Equiv. | Equiv. | Equiv. | Equiv. | Equiv. |
| | oil-free | monooleate | | | | | | | |
| | | succinate | | | | | | | |
| Ex.2 | Silicone | Glyceryl | — | Equiv. | Equiv. | Equiv. | Equiv. | Equiv. | Equiv. |
| | oil added | monooleate | | | | | | | |
| | | citrate | | | | | | | |

*“Ex.” means “Example”.
**“Equiv.” means “Equivalent”.

TABLE 4

| | | | Added amount (% by mass) | | | | | | |
|---|---|---|---|---|---|---|---|---|---|
| | | | of glyceryl monooleate succinate or citrate | | | | | | |
| | | | 0 | 0.02 | 0.04 | 0.06 | 0.08 | 0.10 | 0.12 |
| Ex.*1 | Silicone | Glyceryl | — | Equiv.** | Excel.^{†} | Excel. | Excel. | Excel. | Excel. |
| | oil-free | monooleate | | | | | | | |
| | | succinate | | | | | | | |
| Ex.2 | Silicone | Glyceryl | — | Equiv. | Excel. | Excel. | Excel. | Excel. | Excel. |
| | oil added | monooleate | | | | | | | |
| | | citrate | | | | | | | |

*“Ex.” means “Example”.
**“Equiv.” means “Equivalent”.
^{†}“Excel.” means “Excellent”.

From Examples 1 and 2, it was found that each of the samples with addition of glyceryl monooleate succinate or glyceryl monooleate citrate has a taste and flavor derived from the oil equivalent to that of the base oil (additive-free product), and has a batter coating texture with a better crispiness with an amount added more than 0.02% by mass, in comparison with the base oil (additive-free product).

### INDUSTRIAL APPLICABILITY

The fat and/or oil composition for heat cooking according to the disclosure can be used as a fat and/or oil for frying, for manufacturing fried foods, in particular, in the field of food manufacturing. Further, the fat and/or oil composition can be used in all the kind of foods which require other fats and/or oils for heat cooking.

1. A fat and/or oil composition for heat cooking comprising:
a fat and/or oil;
1 to 5 ppm by mass of silicone oil having a kinetic viscosity of 800 to 5,000 mm²/s at a temperature of 25° C.; and
0.03 to 0.09% by mass of a succinic acid monoglyceride or 0.05 to 0.11% by mass of a citric acid monoglyceride.

2. The fat and/or oil composition for heat cooking according to claim 1, wherein
the succinic acid monoglyceride or the citric acid monoglyceride is glyceryl monooleate succinate or glyceryl monooleate citrate, respectively.

3. A method for manufacturing a fat and/or oil composition for heat cooking, comprising the steps of:
refining a fat and/or oil; and thereafter
adding 1 to 5 ppm by mass of silicone oil having a kinetic viscosity of 800 to 5,000 mm²/s at a temperature of 25° C., and 0.03 to 0.09% by mass of a succinic acid monoglyceride or 0.05 to 0.11% by mass of a citric acid monoglyceride to the refined fat and/or oil.

4. The method for manufacturing a fat and/or oil composition for heat cooking according to claim 3, wherein
the succinic acid monoglyceride or the citric acid monoglyceride is glyceryl monooleate succinate or glyceryl monooleate citrate, respectively.
